(19) United States
(12) Patent Application Publication
(10) Pub. No.: US 2015/0363728 A1
(43) Pub. Date: Dec. 17, 2015

(54) SYSTEM AND METHOD FOR RESOURCE ALLOCATION IN VIEW OF ENERGY FOOTPRINT CONSIDERATIONS

(71) Applicant: Koninklijke Philips N.V., Eindhoven (NL)

(72) Inventor: Maulin Dahyabhai PATEL, Tuckahoe, NY (US)

(21) Appl. No.: 14/764,056

(22) PCT Filed: Feb. 5, 2014
(86) PCT No.: PCT/IB2014/058798

§ 371 Date: Jul. 28, 2015

Related U.S. Application Data
(60) Provisional application No. 61/761,963, filed on Feb. 7, 2013.

(51) Int. Cl. G06Q 10/06; G06Q 50/06

(52) U.S. Cl. CPC G06Q 10/06313; G06Q 50/06

(57) ABSTRACT

This invention discloses a method and apparatus for managing resource allocation in view of energy footprint considerations, wherein allocation of resources is based on factors that contribute to energy consumption. The resources are then ordered in order of their energy consumption so that resources with a smallest level of energy consumption are ranked highest, wherein the rankings are visually presented to the user.

This application is related to the field of energy management and more particularly to a system and method for allocating resources in consideration of their energy consumption footprint.

Energy consumption and energy conservation have become critical elements in business operation. As energy consumption is measured in kilowatt hours and as energy prices continued to rise, the costs to the business continue to increase. However, if businesses can conserve energy by reducing their consumption or reducing wasteful expenditure, then the operational costs of the business may be considerably reduced.

Thus, energy conservation, commonly referred to as “going green,” is advantageous for many businesses in reducing their costs while improving their public images. Research has shown that with proper feedback, awareness and goal setting abilities, individuals can reduce ecological footprint with small behavioral changes. State of the art systems exploit these insights by displaying building energy dashboards at prominent locations such as in an elevator of a multistory building or an information kiosk in the lobby area. There are several limitations of this approach. Energy dashboards display real-time aggregate energy consumed by the building. They do not consider environmental impact of activities performed by individual building occupants. Moreover, building dashboards do not provide personalized feedback to occupants about individual's contributions to building energy consumption. Thus, users are may not be truly made accountable for their share of resource usage.

Existing metrics are inadequate for providing meaningful feedback to individuals. For example, currently there are no metrics that will help a user to select the most efficient room in the building for the meeting. Intuitively, the user may perceive smaller rooms as more efficient but in reality it may not be true. For example, a smaller room in the interior of the building without daylight may consume more lighting energy than a larger room on the perimeter with a daylight harvesting lighting control system. In most commercial buildings, since the cost of the energy varies based on the time of use, it is not apparent as which meeting slot is the most cost effective.

Hence, there is a need for in the industry for methods and systems an individualized feedback that can be readily computed, be intuitively understood across people and environments for managing the electrical energy consumption to reduce consumption while maintaining a favorable working environment for the employees.

It is an object of the present invention to provide methods and systems for managing energy consumption to lower operations costs.

It is an object of the present invention to provide for methods and systems for managing energy consumption while providing that user comfort and convenience are not compromised.

It is an object of the present invention to provide methods and systems for managing energy consumption through allocation of common resources based on energy consumption footprint considerations. It is an object of the present invention to provide data-driven visualizations and feedback of the environmental impact of energy consumption to induce positive attitudes toward environmental stewardship which can lead to conservation of energy resources.

It is an object of the present invention to influence user's choices by presenting the environmental/cost impact of user's choices in a friendly context. In accordance with the principles of the invention, a system for allocating resources considering an energy footprint is disclosed. The system comprises a processor in communication with a memory, the memory including code, which when accessed by the processor causes the processor to: receive a request for a resource allocation, the request including a least one requirement; identify at least one resource satisfying the at least one requirement; determine an energy footprint for each of the identified at least one resource;

rank each of the identified at least one resource based on the determined corresponding energy footprint, wherein a highest ranking is associated with a lowest energy footprint; and visually present said rankings.

In another aspect of the invention, a system for selecting a resource from among a plurality of resources is disclosed. The system comprising: at least one sensor in each of the plurality of resources, the at least one sensor measuring a characteristic within a corresponding resource; a display unit and a processor, the processor: receiving the measured characteristics associated with a corresponding one of the at least one sensor; receiving a request for allocation of a resource, the request including at least one requirement; determining selected ones of said plurality of resources satisfying the at least one requirement; calculating an energy footprint associated with each of the selected resources; ranking the selected resources based on the energy footprint; displaying the ranking; and selecting the resource based on the ranking.

The advantages, nature, and various additional features of the invention will appear more fully upon consideration of the illustrative embodiments to be described in detail in connection with accompanying drawings wherein like reference numerals are used to identify like element throughout the drawings:

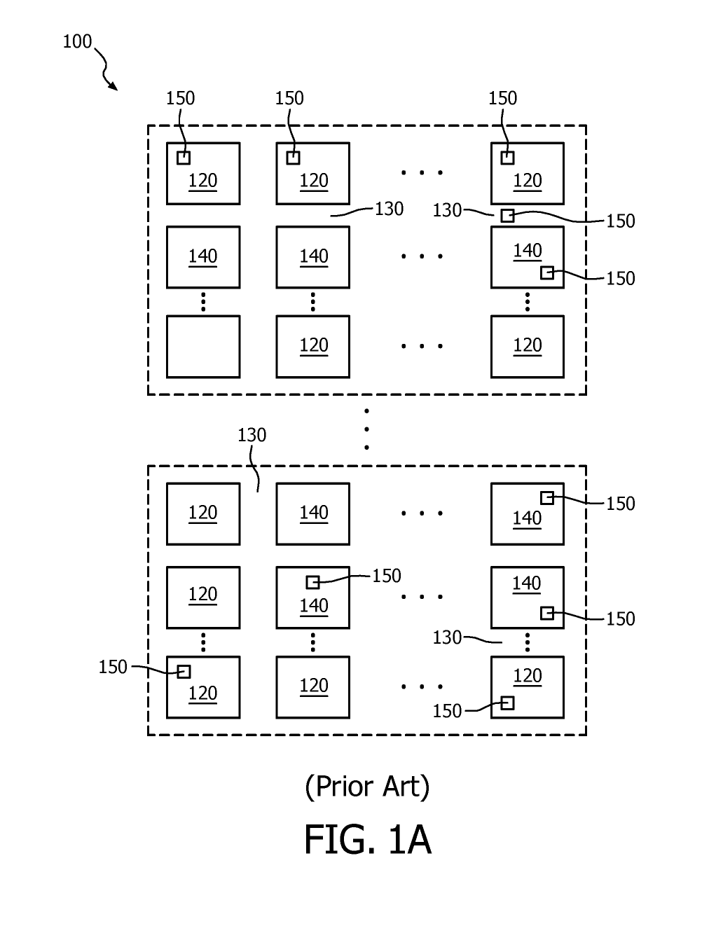

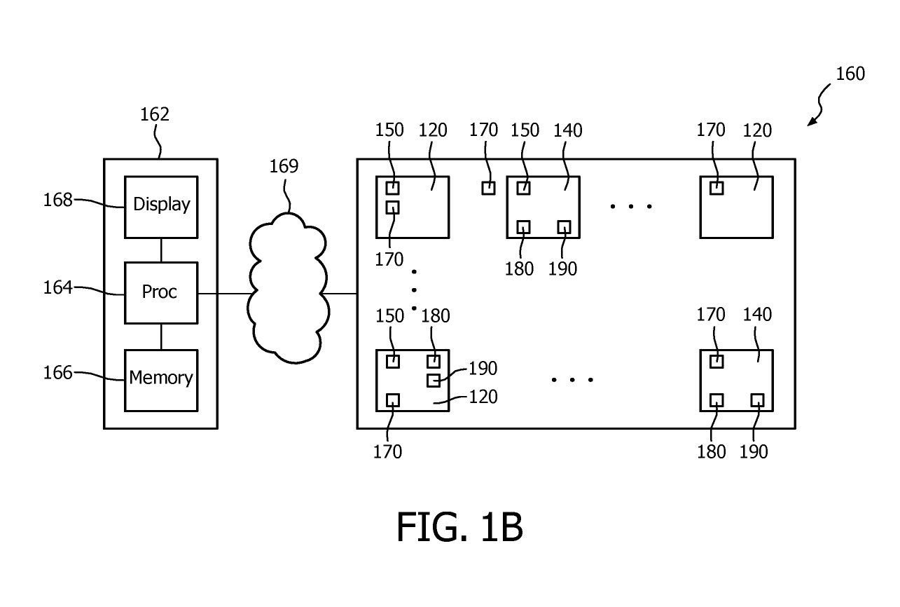

FIG. 1 A illustrates a conventional building configuration.

FIG. 1B illustrates a conventional building management system.

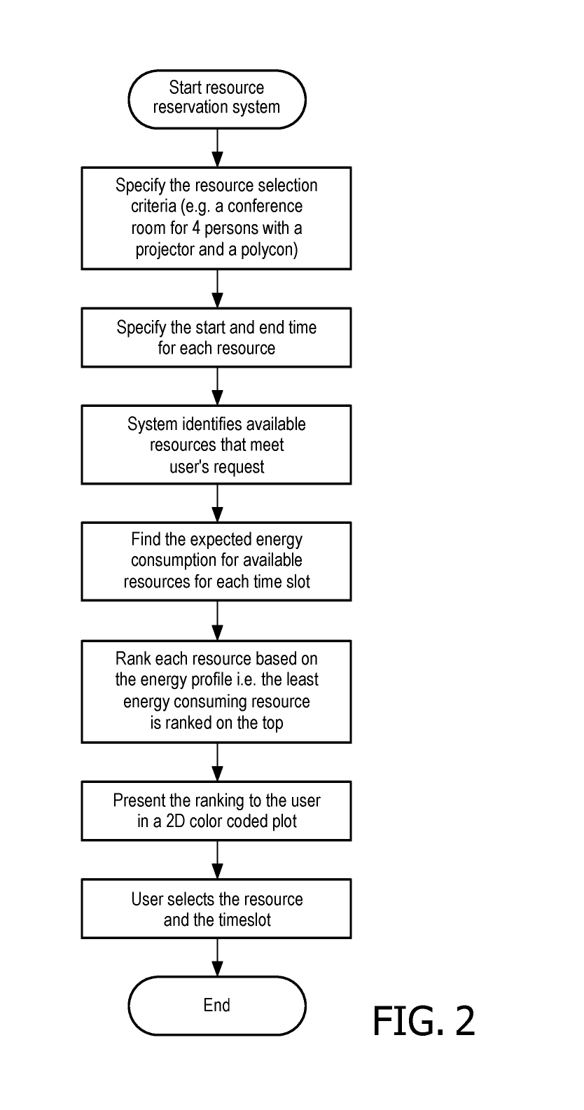

FIG. 2 illustrates a flow chart of an exemplary process in accordance with the principles of the invention; and

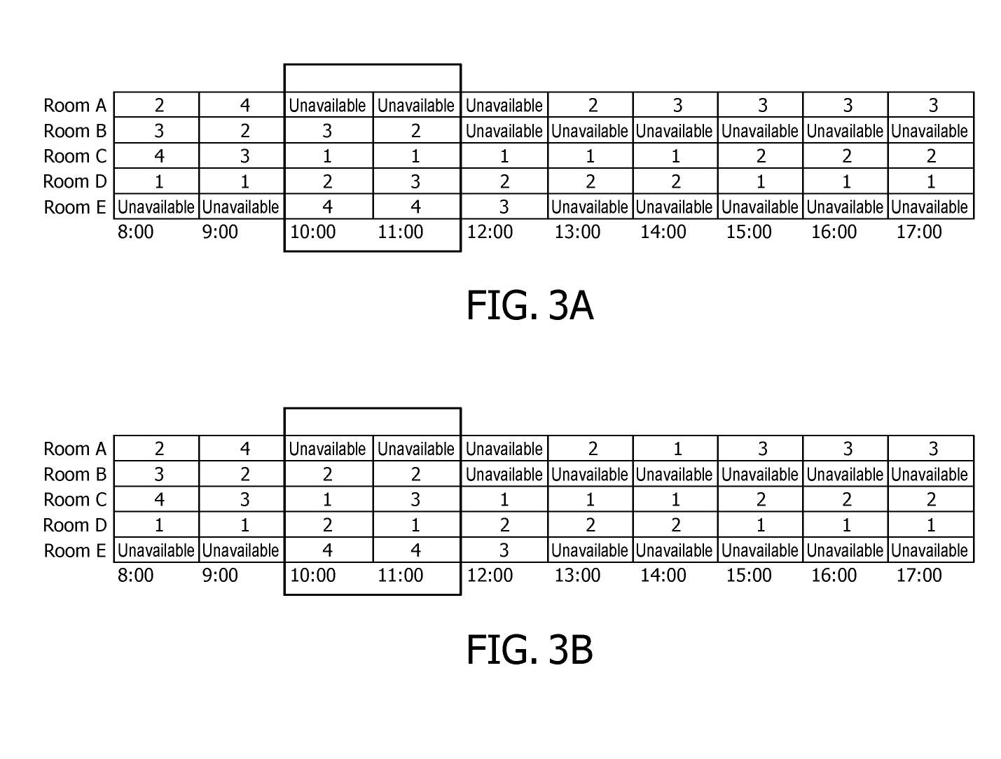

FIGS. 3A and 3B illustrate exemplary displays for scheduling allocations considering energy consumption footprint in accordance with the principles of the invention.

It is to be understood that the figures and descriptions of the present invention described herein have been simplified to illustrate the elements that are relevant for a clear understanding of the present invention, while eliminating, for purposes of clarity, many other elements. However, because these eliminated elements are well-known in the art, and because they do not facilitate a better understanding of the present invention, a discussion of such elements is not provided herein. The disclosure herein is directed also to variations and modifications known to those skilled in the art.

FIG. 1A illustrates an exemplary building configuration 100 including a plurality of floors 105 each including a plurality of rooms (or offices) 120, hallways 130 and shared areas (e.g., conference rooms) 140. In order to conserve energy, energy saving sensors 150 may be installed is selected rooms 120, hallways, 130 and shared areas 140 to reduce energy consumption when the rooms or shared areas are not occupied. For example, the sensors 150 may represent occupancy sensors (or vacancy sensors) that turn lights on when motion is detected and turn room lights off when no motion is detected for a predetermined period of time. Such use of sensors 150 are important is reducing energy consumption in offices and/or areas that are not occupied.

The advances in networked IT and building automation systems offer opportunities to integrate lighting control, HVAC control, computer/equipment energy metering and utility price monitoring with a resource reservation system in accordance with the principles of the invention.

FIG. 1B illustrates an exemplary building energy management system 160 for monitoring energy consumption. The exemplary building management system 160 illustrated may include a centralized processing unit 162 including a processor 164, a memory 166 and a display 167. The building management system 160 may include a network (e.g., a local area network) 169 that may be connected to a plurality of sensors located in designated rooms, offices, hallways and/or shared areas. Network 169 may be a wireless network or a wired network or a combination of wired and wireless networks. For example, the network 169 may be one of, or a combination of, wired, wireless, WiFi and 3G (or 4G) networks. The processing unit 162 may be a dedicated computer system or may be a handheld device that is more portable that may be wirelessly connected to the network 169.

The building management system 160 may also include a plurality of sensors 170 in each, or selected ones, of the illustrated areas (i.e., offices, hallways, conference rooms, shared areas) in addition to the energy saving sensors 150. Sensors 170, which may be located in individual rooms 120, hallways 130, shared areas (e.g., conference rooms) 140, may measure heat, light, and/or humidity characteristics of the area. Also shown are sensors 180 that may be employed to measure a level of light (illuminance) in an area (120, 130, 140) and sensors 190 that may be used to control when heat (or air conditioning) is applied to the room 120, hallway 130, and/or shared area 140.

Thus, the building energy management system 160 receives information regarding each room, hallway or shared area (hereinafter referred to as “area”) and may determine energy usage in each area. In some cases, the energy management system may attempt to reduce energy costs by maintaining heat (or air-conditioning) in selected areas at a first predetermined temperature and then when one or more of the selected areas is scheduled to be occupied for an expected duration, the heating or air conditioning may be adjusted so that the temperature in the selected area is sufficient to satisfy operating conditions (i.e., sufficient heat, air conditioning, lighting, etc.) so that the area is comfortable for its occupiers at the scheduled time and for the expected duration.

However, the conventional energy management system 160 fails to consider the energy footprint (i.e., energy consumption) of the selected area when the area is scheduled for use. That is, typically small rooms are allocated when a small number of participants are expected to use a conference room while larger conference rooms may only be allocated when a large number of participants is expected. However, if the energy footprint of the smaller room is determined to be greater than that of the larger room, then it may be economically viable for the larger room to be allocated for a smaller number of participants. For example, a large conference room with large windows facilitating daylight admission may require less energy consumption during daytime hours than a smaller conference room with no windows. Thus, because the larger conference room may have a smaller energy footprint than a smaller conference room when factors such a room location and orientation, time of day, seasonal temperature, etc., are considered in determining energy consumption, the selection of a larger conference room may provide a greater savings to the company then the selection of a smaller room. Hence, the larger conference room may be more economically and environmentally suitable for the desired meeting than a smaller room.

FIG. 2 illustrates a flow chart 200 of an exemplary process for allocating resources (e.g., conference rooms or other shared areas) considering the energy footprint or energy consumption in the allocation of the resource.

At block 210, a user may specify a set of criteria or requirements required to satisfy a specific condition. For example, in the context of conference room allocation, as an example, the user may specify a number of persons attending the meeting, the types and number of multimedia equipment (e.g., projectors, writing boards, teleconferencing capability, etc.) necessary for the meeting to be successful. At block 220, a start and end time of each resource is specified (i.e., a duration). At block 230, the resources (e.g., conference room) that satisfy the user's criteria or requirements are identified. For example, N number of conference rooms may be determined to satisfy one or more of the user's criteria.

At block 240, a determination is made of the expected energy consumption for each of the identified resources. The expected energy consumption may be determined based on the lighting necessary, the heating necessary, the air conditioning necessary, etc. to create an operating environment that is suitable for the persons within the resource. For example, the lighting necessary may be determined, in part, based on whether the resource includes a window, in which natural light may be used to reduce the amount of artificial light. In addition, if a window is available, then the orientation of the window with respect to the sun may be further considered in determining the amount of artificial light necessary. In addition, a time of the allocation of the resource may be used to determine the amount of artificial light necessary. As another example, a windowed conference room oriented toward the sun, may require less artificial light then a conference room without a window or with a window orientation opposite to that of the sun's position. Similarly, a windowed conference oriented to the sun may require less artificial light at 11 am, when the sun is rising then at 4 pm when the sun is setting. In addition, the outside weather conditions may further be considered in determining the lighting necessary. For example, a windowed conference oriented to the sun may require less artificial lighting on a sunny day then on a cloudy or rainy day.

Similarly, the energy consumption to satisfy heating requirements may consider the outside room temperature and/or the temperature of the area (e.g., conference room) prior to the scheduled time. Thus, a room that is in-use prior to the scheduled time, which has already been provided adequate heating (or air-conditioning) conditions, may have a smaller energy consumption footprint than a similar sized or smaller room that is (or was) empty prior to the scheduled time. Thus, the energy necessary to heat (or cool) the similarly sized or smaller room may be greater than the energy consumption to maintain an existing heated (or air-conditioned) room. In addition, the energy consumption to satisfy the heating (air-conditioning) requirements may further consider whether the conference room is a windowed conference room oriented toward the sun, wherein heating from the sun may reduce the amount of energy necessary to heat a similar sized room lacking a window.

Similar analysis may be performed to determine the energy consumption necessary to satisfy air conditioning, humidity, and lighting requirements.

One metric in determining energy consumption may be the cost to provide the necessary lighting, heating, air conditioning, etc. The cost for lighting may consider the types of electric bulbs used in the area. For example, the use incandescent bulbs may have a higher cost than florescent or compact florescent bulbs, which may have a higher cost than Light Emitting Diode (LEDs). As another example, a cost of heating or air conditioning may be determined based on an initial temperature, as measured by one or more sensors, and the projected amount of heat (or air-conditioning) necessary to achieve a desired temperature by raising the temperature (i.e. heating) or reducing an existing temperature (i.e., air-conditioning). A second metric may be the amount of green-house gases generated to satisfy the required lighting, heating and/or air-conditioning. For example, generation of electrical energy using coal fired power plants may have a higher energy consumption footprint than electrical energy generated using nuclear energy which may have a higher energy consumption footprint than electrical energy generated by wind or solar generation.

Thus, a comprehensive determination of the energy footprint considers at least the energy consumption footprint to achieve a desired operating condition (i.e., temperature, lighting, humidity to provide for reasonable client comfort) and the energy consumption footprint to maintain the operating condition.

In one aspect of the invention, the energy consumption to maintain acceptable threshold levels of operating conditions may be derived using a moving average of historic energy consumption data in a selected time slot for each resource. For example, an average energy consumed in a resource (e.g., a conference room) in predetermined time periods may be determined when the resource is occupied during the predetermined time periods (e.g., hourly). In periods when the resource is unoccupied, the energy consumption does not contribute to the energy consumption required during periods of occupancy. The historical data may further be accumulated over predetermined periods of time (i.e., week, month, year, season, etc.) so as to determine an average energy consumption for the resource in the predetermined time period.

At block 250, each of the resources is ranked in order of increasing energy consumption, wherein the resource with the lowest energy consumption is ranked highest.

At block 260, the ranking of the resources is presented to the user and at block 270 the user selects the resource (i.e., manual selection) or the resource is selected for the user, (i.e., automatic selection). In one aspect of the invention, the selection of the resource is based on a lowest energy consumption.

FIG. 3A illustrates an example of an exemplary presentation of the resource allocation in accordance with the principles of the invention. In this illustrative example, the resources (identified as Room A-E) that satisfy at least one of at least one requirements or criteria (e.g., multimedia capability, number of participants, etc.) of a user requesting a resource may be arranged along a vertical axis and a time of day is arranged along a horizontal axis. The energy footprint of each resource may then be indicated by a visual differential scheme, such as a number scheme or a color scheme or other visually distinguishable means, for example, to describe its ranking during a particular period.

FIG. 3A illustrates an exemplary display of resource allocation in accordance with the principles of the present invention, wherein meeting room availability and energy profile ranking of rooms are depicted. In this exemplary case, a user wants to setup a two hour meeting of 4 people between 10:00 am and 12:00 noon. There are 5 rooms (A-E) that meet the user's criteria (e.g. multimedia requirements, number of participants, etc.). In this illustrated embodiment, the ranking of each of the rooms is displayed in the time slot 10:00am to 12:00 noon. The display of rankings of rooms A-E in other time slots correspond to requests made by other users for the corresponding time slots or may represent alternative time slots that are would satisfy the user's requirements for allocation of a resource.

In this illustrated embodiment of the invention, the rankings of rooms A-E is presented by numbering each of the rooms with a ranking number, wherein ranking 1 represents a highest ranking (i.e., lowest energy consumption) and ranking n (where n represents 5, the number of rooms) is the lowest (i.e., highest energy consumption). In another embodiment of the invention the rankings may be presented as n to 1, wherein n represents the lowest energy consumption and 1 represents the highest energy consumption. In another embodiment of the invention, the ranking may be color coded (e.g., red-highest ranking (i.e. lowest energy consumption), orange-second highest ranking . . . blue-lowest ranking). Alternatively, the color ranking may be from blue (highest; lowest energy consumption) to red (lowest). In another embodiment the rankings may be shown with cross-hatching, wherein an increased density of the cross-hatching, for example, may indicate lower ranking (i.e., higher energy consumption). Alternatively, the ranking may be from highest density cross-hatching to lowest density cross-hatching to indicate highest to lowest ranking (i.e., lowest to highest energy consumption).

Accordingly, the rankings are visually differentiated in order to quickly determine the ranking of the resources.

In this illustrative example, the ranking of each room is indicated by a ranking number from 1 to 5 (i.e., n equal 5). Room C, which satisfies the user's criteria, is ranked first between 10:00 am and 12:00 noon and room A is indicated as being unavailable during this period as it may be previously scheduled or undergoing maintenance.

Thus, the user may be encouraged to schedule the meeting in room C between 10:00 am and 12:00 noon. Similarly, with a centralized room allocation system, the user may be allocated room C so that the employer may save costs in allocating rooms based on their energy footprint.

Alternatively, the use may select room C between 13:00 and 15:00 hours as this selection also has a favorable energy footprint.

As would be appreciated, room ranking can change dynamically. For example, assume room A becomes available due to a cancellation during a selected 10:00 to 12:00 noon resource allocation and it may be determined that room A has a smaller energy footprint than room C. Then, the user may be informed that room A has become available and it has a smaller energy footprint. The user may then select room A for scheduled duration of the allocated resource or room A may be allocated to the user, as this allocation results in an energy savings for the employer, in accordance with the principles of the invention. The user (and the participants) may be informed by an electronic means (i.e., e-mail or text messaging), verbally or visually of the room allocation and/or a change in the room allocation.

In another aspect of the invention, if 2 out of 4 attendees, for example, decline the meeting invitation then, the allocation of the resource may be re-evaluated based on the decreased number of persons in attendance. In this case, a smaller room may be determined to be better for the meeting as the smaller room may have a smaller energy footprint, based on the number of participants.

FIG. 3B illustrates an example of the re-evaluation of the determination of the allocation of the resources that satisfy the user's requirements. In this case, during the time period 10:00 am-12 noon, no single room has a lowest energy footprint over the required time period. Room C, for example, has a lowest energy footprint during a first hour and a footprint that is higher than that of room B during a second hour. However, room B has a second lowest energy footprint during both hours and the system may indicate that the use of room B, having a second lowest energy footprint, may be desirable based on a total energy consumption over the duration of the requested resource. Hence, the user or a central allocation system, may select room B over room C, as a total energy footprint over the entire period may be effectively lower.

The user or the system can be sent a notification, via e-mail, text messaging, voice mail, etc., to the participants of the updated selection based on the new ranking of available rooms caused by a change in a number of participants. In another aspect of the invention, assuming room allocation is performed several days in advance and certain assumptions regarding weather conditions are determined to no longer be valid in determining a room allocation, a re-evaluation of the allocation of the room assignment may be performed to either validate the original room allocation or present a different allocation. Thus, if the allocation is made several days in advance, assuming sunny conditions, and on the day of the allocation the weather conditions are not sunny, then a re-evaluation of the allocation may be performed. Other criteria for re-evaluating room allocations may be a change in the time of the required resource, a change in the duration of the required resource, a change in the number of participants and a change in the multimedia requirements. The allocation or re-allocation of resources may then be presented to the user in the form of an electronic communication (e.g., e-mail, text message), verbally (e.g., telephone) or visually (e.g., insertion into the user's calendar).

In one aspect of the invention, when the user has identified the other participants, the other participants may similarly be notified with regard to the resource allocation. Although the invention has been described with regard to conference room allocation, it would be recognized that the principles of the invention may be applied to other types of resources that are scheduled for usage in order to allocate the resource based on its energy footprint. For example, many businesses manage a lesser number of office spaces at a location for a greater number of employees at the location wherein office space is shared among the employees. With the availability of telecommunication, many of the employees need not be present at the location. Hence, in accordance with the principles of the invention, office spaces may be allocated based on the energy consumption required to maintain a limited number of employees at the location.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

The above-described methods according to the present invention can be implemented in hardware, firmware or as software or computer code that can be stored in a recording medium such as a CD ROM, an RAM, a floppy disk, a hard disk, or a magneto-optical disk or computer code downloaded over a network originally stored on a remote recording medium or a non-transitory machine readable medium and to be stored on a local recording medium, so that the methods described herein can be rendered in such software that is stored on the recording medium using a general purpose computer(s), or a special processor(s) or in programmable or dedicated hardware(s), such as an ASIC or FPGA. As would be understood in the art, the computer(s), the processor(s), microprocessor controller(s) or the programmable hardware(s) include memory components, e.g., RAM, ROM, Flash, etc. that may store or receive software or computer code that when accessed and executed by the computer(s), processor(s) or hardware(s) implement the processing methods described herein. A computer program may be stored/distributed on a suitable medium, such as an optical storage medium or a solid-state medium supplied together with or as part of other hardware, but may also be distributed in other forms, such as via the Internet or other wired or wireless telecommunication systems. In addition, it would be recognized that when a general purpose computer(s) accesses code for implementing the processing shown herein, the execution of the code transforms the general purpose computer(s) into a special purpose computer(s) for executing the processing shown herein.

The terms “a” or “an” as used herein are to describe elements and components of the invention. This is done merely for convenience and to give a general sense of the invention. The description herein should be read to include one or at least one and the singular also includes the plural unless indicated to the contrary.

The term “comprises”, “comprising”, “includes”, “including”, “as”, “having”, or any other variation thereof, are intended to cover non-exclusive inclusions. For example, a process, method, article or apparatus that comprises a list of elements is not necessarily limited to only those elements but may include other elements not expressly listed or inherent to such process, method, article, or apparatus. In addition, unless expressly stated to the contrary, the term “or” refers to an inclusive “or” and not to an exclusive “or”. For example, a condition A or B is satisfied by any one of the following: A is true (or present) and B is false (or not present); A is false (or not present) and B is true (or present); and both A and B are true (or present).

While there has been shown, described, and pointed out fundamental and novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention.

It is expressly intended that all combinations of those elements that perform substantially the same function in substantially the same way to achieve the same results are within the scope of the invention. Substitutions of elements from one described embodiment to another are also fully intended and contemplated.

1. A system for allocating resources considering an energy footprint of said resources, said system comprising:
a processor in communication with a memory, the memory including code, which when accessed by the processor causes the processor to:
receive a request for a resource allocation, said request including at least one requirement;
identify at least one resource satisfying said at least one requirement;
determine an energy footprint for each of the identified at least one resource;
rank each of the identified at least one resource based on a determined corresponding energy footprint, wherein a highest ranking is associated with a lowest energy footprint; and
visually present said rankings.

2. The system of claim 1, further comprising:
selecting one of said at least one resource based on said ranking.

3. The system of claim 1, wherein said visual presentation of said rankings is based on one of: a color system, a number system and a cross-hatching scheme.

4. The system of claim 1, wherein said desired requirement is selected from a group consisting of: a time of day, a scheduled duration, a number of participants, and an equipment need.

5. The system of claim 1, wherein said energy footprint for each of the identified at least one resource is determined based on an energy footprint necessary to achieve a desired operating condition and an energy footprint necessary to maintain said desired operating condition.

6. The system of claim 5, wherein said energy footprint to maintain said desired operating condition for each of the identified at least one resource is determined based on an amount of energy consumed using historical data.

7. The system of claim 6, wherein said historical data for each of the identified at least one resource comprises energy consumption during a period of resource usage in a predetermined time period over a predetermined period of time.

8. The system of claim 7, wherein said predetermined time period is hourly.

9. The system of claim 7, wherein said predetermined period of time is one of: weekly, monthly, yearly.

10. The system of claim 1, further comprising:
at least one sensor in each of said at least resources said at least one sensor providing corresponding information to said processor.

11. The system of claim 10, wherein said at least one sensor for measuring a characteristic selected from a group consisting of: light intensity, occupancy, humidity and temperature.

12. A system for selecting a resource from among a plurality of resources, said system comprising;
at least one sensor in each of the plurality of resources, said at least one sensor measuring a characteristic within said resource;
a processing system in communication with each of the at least one sensor, said processing system comprising:
a display system:
a processor:
receiving said measured characteristics associated with a corresponding one of said at least one sensor in each of said plurality of resources;
receiving request for a resource, said request including at least one requirement associated with said resource;
determining selected ones of said plurality of resources satisfying said at least one requirement;
calculating an energy footprint associated with each of said selected resources;
ranking said selected resources based on said energy footprint, said selected resources having a lowest energy footprint are ranked highest;
causing display of said selected resources in an order of ranking on said display system; and
selecting one of said displayed selected resources based on said displayed ranking.

13. (Original The system of claim 12, wherein said energy footprint is determined based on achieving a desired operating condition within said selected ones of said plurality of resources.

14. The system of claim 12, wherein said rankings are displayed in one of: a color scheme, a number scheme and a visual differentiating scheme.

15. The system of claim 13, wherein said energy footprint is further determined based on an energy footprint necessary to maintain said desired operating condition in said corresponding resource.

16. The system of claim 15, wherein said energy footprint necessary to maintain said desired operation condition is based on historical energy usage in said resource.

17. The system of claim 15, wherein said energy footprint necessary to achieve said desired operating condition is based on said measured characteristics.

18. The system of claim 12, further comprising:
providing notification of said selected resource.

19. The system of claim 18, wherein said notification is one of: electronic, visual, and verbal presentation.

20. The system of claim 12, wherein said step of selecting said resource is one of: selection based on one of: a lowest energy footprint and manually.

21. A method for managing allocation of resources, said method operable in a processor, said method causing said processor to:
determine at least one resource from among a plurality of resources satisfying at least one requirement;
determine an energy consumption of the determined at least one resource;
rank said at least one resource, wherein a resource with a lowest energy consumption is of a highest rank;
display said at least resource in an order of ranking; and
allocate one of said at least one resource based on said ranking.
